(19) United States
(12) Patent Application Publication
(10) Pub. No.: US 2009/0221278 A1
(43) Pub. Date: Sep. 3, 2009

(54) Method for Customizing the Operation of a Telephonic Terminal

(75) Inventors: Stefano Spelta, Torino (IT); Fabio Bellifemine, Torino (IT); Maria Cristina Ronchini, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TELECOM ITALIA S.P.A., Milano (IT)

(21) Appl. No.: 12/087,284

(22) PCT Filed: Dec. 30, 2005
(86) PCT No.: PCT/EP2005/014128

§ 371 Date: Jan. 14, 2009

(51) Int. Cl. H04M 3/00

(52) U.S. Cl. 455/418

(57) ABSTRACT

A method serves for customizing the operation of a telephonic terminal, in particular a mobile telephonic terminal of a user. A profile file is provided for storing information relating to operation parameters of the telephonic terminal. The information stored in the profile file can be modifiable by the user. Additionally, a policy file is provided for storing information relating to the possibility to modify one or more of the operation parameters by the user. Typically, a profile manager software module manages the profile file and a policy manager software module manages the policy file. When a user attempts to carry out modifications on information stored in the profile file, the profile managing module interacts with the policy managing module in order to check the possibility to carry out the modifications and to get the authorisation or the denial from the policy managing module.

### FIELD OF THE INVENTION

The present invention relates essentially to a method for customizing the operation of a telephonic terminal, in particular a mobile telephonic terminal.

### BACKGROUND OF THE INVENTION

The possibility to customize the operation of telephonic terminals, particularly mobile telephonic terminal (e.g. mobile phones), by their users is continuously increasing and tend to cover every aspect of their operation. For example, many mobile phones currently on the market allow to the users the following customization:
modification of the settings relating to the graphic aspect of the user Interface (colours, character fonts, background image, icons, . . . ),
modification of the interaction mode with the user interface (sounds and warnings, links of the applications to specific functional push buttons, organization of the menus, display mode of the available applications, internationalization options, text input mode, . . . ),
modification of the links to local and remote networks (URL links, local documents links, . . . ),
addition, deletion and change of the applications resident in the telephonic terminal,
network settings modification (service centres telephone numbers for messaging functions, configuration for data transfer via mobile networks connections, configuration for data transfer via short-range wireless connections, restrictions on outgoing/incoming calls, . . . ),
general modification of parameters specific of the mobile telephonic terminal (energy saving, timeout values, keyboard lock, . . . ).

At present, the user can often customize all the above mentioned aspects, the only limitations being the technical features of the telephonic terminal; this can usually be done through a software module called “profile manager” installed within the telephonic terminal.

In those cases when the user can not customize all above mentioned aspects, the telephone operator has previously asked the manufacturer of a telephonic terminal to design a specific “profile manager” having a specific software code (specific instructions and/or specific variables) that does not provide to the users certain customization; often this specific “profile manager” is a variation derived from a standard (and full operative) “profile manager” and is called a “build”.

From US 2004/0201632 it is known a method of specifying a visual style for a set of graphical components for use on a computer system having a graphical operating environment. The method includes providing a schema file of available graphical components for which a visual style can be created. In the schema file, each component is defined by a unique class name. The method further includes selecting graphical components from the schema file that are desired to have a defined visual style. Properties are then assigned to these selected components according to the desired visual style, and pairs of selected graphical components and corresponding assigned properties for the defined visual style are grouped together in a class data file that defines the overall appearance for the defined visual style.

From U.S. Pat. No. 6,400,958 it is known a terminal for a communication network, the terminal being capable of supporting a plurality of applications and having means of communicating user messages. The terminal comprises means for receiving user messages having data and a header relating to one of the applications and means for addressing the data to a respective application according to the header. In an embodiment the user messages are short messages and the data comprises characters in the short message.

From US 2005/0143067 it is known a solution for a method and arrangement for customization of services and applications in telecommunication networks. According to this solution, the user is able to access his/her services and applications from any terminal in any network. The following features are included in this solution: all the user's settings and preferences for all his services and applications are incorporated in a user profile, the user profile is made available in the World-Wide-Web, i.e. the Internet, as an XML web service, the user is allowed to access and modify his/her profile via a user profile web portal, services and applications can access the user profile via a web interface.

### SUMMARY OF THE INVENTION

The Applicant has noticed that for a telephonic operator, in particular a mobile telephonic operator, there could be the wish or the need to restrict the freedom of a user to customize the operation of his telephonic terminal, in particular his mobile telephonic terminal; specifically, a telephonic operator may wish or need to set specific permissions to a user relating to the customization, e.g. to set specific rules and/or limitations. Such restrictions may be due to:
technical reasons: it is important to guarantee that wrong settings by the user do not damage the terminal, do not stop correct operation of the telephonic terminal and do not stop operation of the telephonic network,
commercial reasons: for example, a cellular phone is sold at a reduced price (or is provided to a user for free) with certain restriction relating to its user interface (e.g. background image, icons, sounds, . . . ) or to its use (e.g. possibility to make phone calls or send messages only through a predetermined telephonic operator, possibility to dial only the telephone numbers of a predetermined telephonic operator, . . . ).

Additionally, the Applicant has noticed that a telephonic operator, in particular a mobile telephonic operator, may be interested in customizing telephonic terminals for particular groups or categories of users. As a first example, users having a low familiarity for technology may be interested in a simplified and protected environment. As a second example, a company may be interested in providing to its employees mobile phones that can do only telephone calls (i.e. no SMS or MMS and therefore no telephone number of the messaging service centre is to be stored in the user profile) and only to the company telephone numbers.

The solution according to the prior art either have a low flexibility or do not meet the above mentioned requirements.

Finally, the Applicant has noticed that a telephonic operator, in particular a mobile telephonic operator, may be interested in differentiated in basically three customization levels for the user:
no permission (the user can not make any modification),
full permission (the user is free to make any modification),
limited permission (the user can make modifications within predetermined limits, e.g. within a range of values, within a set of values, . . . ).

This differentiated customization level may apply to one operation parameter, to all operation parameters, to a set or category of operation parameters of the user profile.

All the above customization requirements may be static (i.e. they do not change as time passes) or dynamic (i.e. they do change as time passes); therefore, it would be useful to have a constrained customization method that can be used dynamically and easily, possibly with a minimum impact on the user operations as well as on all the other functions of the telephone.

The Applicant have considered using two separate files in a telephonic terminal: a profile file and a policy file; the profile file stores information relating to operation parameters of the telephonic terminal; the policy file stores information relating to the possibility to modify one or more of the operation parameters of the profile file. Applicant have realized that by using the above two files a telephone operator can specify different policies for different subscribers, and change policies at any time, with no impact on those user defined profile settings that are not affected by the policy change.

The two files are preferably completely distinct from each other so that they may be managed independently from each other both by the telephonic operator and by the telephonic terminals.

In the telephonic terminal, two independent software modules, a profile manager and a policy manager, may advantageously be provided for managing respectively the profile and the policy. These two modules may interact between each other for assuring that modifications of the user profile requested by the user comply with the policy set by the telephonic operator.

Additionally or alternatively, it may be provided that the policy manager intercepts any attempt to modify the user profile and assures that these modifications comply with the policy set by the telephonic operator.

The present invention will be better described in the following with reference to a preferred and non-limitative embodiment and in conjunction with the annexed drawings.

### BRIEF DESCRIPTION OF THE DRAWINGS

FIG. 1 shows a simplified block diagram of an architecture of a system according to an embodiment of the present invention,

FIG. 2 shows flows of interaction between various software modules within the architecture of FIG. 1 when an application modifies the user profile without user interaction,

FIG. 3 shows flows of interaction between various software modules within the architecture of FIG. 1 when an application modifies the user profile with user interaction, and

FIG. 4 shows flows of interaction between various software modules within the architecture of FIG. 1 when a telephonic operator changes one or more permissions to a user.

It is to be understood that the following description and the annexed drawings are not to be interpreted as limitations of the present invention but simply as exemplifications.

### DETAILED DESCRIPTION OF THE INVENTION

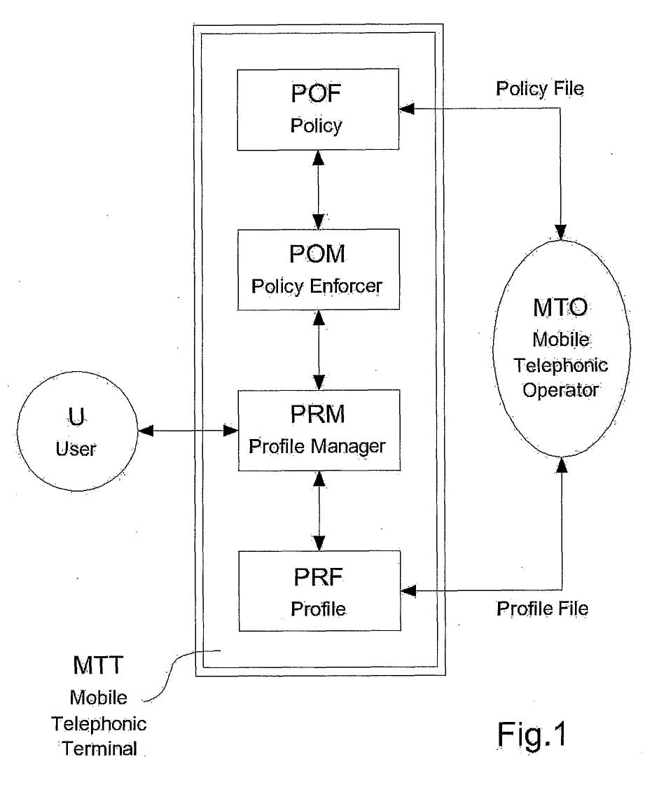

The basic architecture of the system according to the present invention is shown in FIG. 1.

In FIG. 1, a Mobile Telephonic Terminal MTT is shown that interacts with a User U and a Mobile Telephonic Operator MTO.

In FIG. 1, two software modules, two repositories or archives and two files are shown; it is clear that many other software modules (i.e. programs) and repositories or archives (i.e. data) are typically comprised in any mobile telephonic terminal together with its hardware.

There is a software module called “Profile Manager”, PRM, and a software module called “Policy Enforcer POM”, POM; the first module manages a repository called “Profile”, PRF, and the second module manages a repository called “Policy”, POF.

The Profile PRF is used for storing Information relating to the operation parameters of the Mobile Telephonic Terminal MTT and is generally known as “user profile”; operation parameters are for example the following:
colours used by the user interface for user interaction,
character font used by the user interface for user interaction,
background image used by the user interface for user interaction,
icons used by the user interface for user interaction,
brightness used by the user interface for user interaction,
sounds used by the user interface for user interaction,
volume used by the user interface for user interaction,
assignment of functions to keyboard keys,
menus organization and composition,
display mode of available applications,
international settings,
text input mode,
local and remote networks links,
resident applications,
telephone numbers of service centres for SMS and/or MMS,
utility telephone numbers (e.g. helpdesk of telephonic operator),
parameters for data transfer through mobile network connection,
parameters for data transfer through short-range connection,
incoming/outgoing call limitations,
energy saving settings,
timeout values,
keyboard lock parameters.

The Profile Manager PRM is an application that allows a user to read and update his own user profile stored usually in the hardware of a mobile telephonic terminal. More specifically, this kind of application allows a user to read the various parameters stored in the user profile usually through a number of linked menus, to modify one or more of these parameters (if desired by the user) and to update the user profile.

The manufacturer of a mobile telephonic terminal stores a standard user profile at the time of manufacturing; thereafter, a mobile telephonic operator often updates the standard user profile in order to customize it for its subscribers. Alternatively, the mobile telephonic operator may ask the manufacturer to directly store a customized user profile for its subscribers at the time of manufacturing. These two possibilities are conceptually similar and are represented by an arrow labelled as “Profile File” starting from the Mobile Telephonic Operator MTO and ending to the Mobile Telephonic Terminal MTT; in fact, the storage of a user profile into a mobile telephonic terminal may correspond to (or be considered as) the transfer of a profile file into the terminal.

Finally, the User U may further customize the user profile according to his own preferences through the Profile Manager PRM application.

It is advantageously provided by the Profile Manager PRM that the User U may restore the Operator's settings or the Manufacturer's settings of the Profile PRF.

Till now, the user profile is stored within the mobile telephonic terminal coded according to a proprietary format related to the manufacturer of the mobile telephonic terminal; till now, also the profile manager is a software module designed by the manufacturer of the mobile telephonic terminal and stored by it within the terminal at the time of manufacturing; the Profile Manager PRM is designed to process the Profile PRF and the Profile File according to their own coded format.

At present, very often, a user is totally free to modify the user profile of his mobile telephonic terminal and the profile manager guides him in the operations connected thereto.

Sometimes, a mobile telephonic operator wishes that some parameters of the user profile may not be modified by some of his subscribers, for example those subscribers having a certain subscription agreement. At present, in this case, the mobile telephonic operator asks one or more mobile telephonic terminal manufacturers to modify the profile manager on one or more of their products so that those parameters can not be modified.

According to the present invention, the above mentioned wish by the Mobile Telephonic Operator MTO may be satisfied in a much more efficient and effective way.

This is essentially achieved through the Policy POF that stores information relating to the possibility to modify one or more of the operation parameters of the Profile PRF by a user.

The Policy POF may be stored within a telephonic mobile terminal as in the embodiment of FIG. 1 and, advantageously, may be managed by the software module Policy Enforcer POM that is the manager of the policy.

Typically, the policy will be provided to the telephonic terminal as a policy file by a telephonic operator; in FIG. 1, this possibility is represented by an arrow labelled as “Policy File” starting from the Mobile Telephonic Operator MTO and ending to the Mobile Telephonic Terminal MTT. The policy file may be received from the telephonic operator during operation of the telephonic terminal e.g. through the mobile network.

The Policy File is advantageously coded in a standard format; in this way the same policy file may be provided by the same telephonic operator to telephonic terminals by different manufacturers.

Typically, the Policy Enfoncer will be a software module designed by the manufacturer of a telephonic terminal and stored by it within the terminal at the time of manufacturing; clearly, the Policy Enforcer POM is designed to process the Policy File according to its own coded format.

Through the Policy File, the telephonic operator will be able to specify the permissions given to the users to modify the user profile, i.e. to customize his telephonic terminal.

The Policy Enforcer POM has the task to interpret the Policy File and to apply these permissions when the user tries to modify the user profile.

According to the embodiment of FIG. 1, conceptually, when a user tries to modify an operation parameter of the user profile he interacts with the Profile Manager PRM; the Profile Manager PRM Interacts with the Policy Enforcer POM to check whether the modification requested by the user is allowable or not; if yes the modification is applied and if not the modification is not applied and an error message may be issued.

In this way, it is easy to allow a telephonic operator to specify different policies for different subscribers. It is also easy to change a policy at any time. This simply requires to provide new policy files or updated policy files to telephonic terminals; this does not imply to provide other files (or in general other data), e.g. profile files, to the telephonic terminals. By the way, the same policy file may be sent very efficiently to a plurality of telephonic terminals e.g. through a multicast or broadcast procedure. This is an important advantage of the present invention: dynamic update of the Policy File POF, by the telephonic operator, is independent of, and does not impact on, the Profile File PRF of the users. In other words, when the telephonic operator remotely updates the Policy File POF of a user, the set of current values of the collection of operation parameters of the telephonic terminal does not change (e.g. the user continues to see his preferred background, font, . . . ).

It is worth mentioning that the Policy POF and or the Profile PRF can be stored within the Mobile Telephonic Terminal MTT according to proprietary formats. Alternatively, according to the present invention, one possibility could be to code the Profile File and the Policy File according to standard formats and to use the same standard formats also for storing the Policy POF and the Profile PRF within the Mobile Telephonic Terminal MTT.

Additionally, it is worth noting that even if in FIG. 1 the Policy POF and the Profile PRF are shown as separate entities from their managing modules, i.e. respectively Policy Enforcer POM and Policy Manager, they could be integrated within their corresponding managing modules.

It is worth to mention that the distinction between the Profile File PRF and the Policy File POF can advantageously be exploited in, for instance, dual-SIM or multi-SIM subscriptions: it enables the user to have a single Policy File POF (that would be mapped to his subscription agreement and that would specify how the user can modify his Profile Files PRFs) and a plurality of Profile Files PRFs (e.g. one for each terminal, or one for each SIM Card, where each PRF specifies the set of current values of the collection of operation parameters of the telephonic terminal).

Policy File

According to the present invention, the policy file may be provided by a mobile telephonic operator separately from other files (e.g. profile files) that describe the properties of the customizable elements.

Advantageously, the fact that the policy file is provided separately from other files present in the mobile telephonic terminal allows the mobile telephonic operator to dynamically update the permissions simply by transferring into the mobile telephonic terminal a new or updated policy file without the need to modify any software module (e.g. the Profile Manager PRM or the Policy Enforcer POM) present in the mobile telephonic terminal. Specifically, the permissions (i.e. the modification rules of the parameters of the user profile) are preferably kept separated from the user profile (i.e. the actual values of the various parameters of the user profile). In general, this may allow to update the permissions without changing in any way the user profile; In other words, the user may not even realize that the mobile telephonic operator has changed the customization rules of his mobile telephonic terminal, unless the current user profile is not compatible with the new rules, i.e. with the updated policy file.

In the course of the present patent application, by “policy” It is meant a set of permissions relating to the access and to the modification of parameters (relating to e.g. graphic aspect, network configuration, service configuration, menus organization and composition) comprised in a user profile.

The policy file is advantageously expressed through a standard and extensible file format (e.g. XML, i.e. Extensible Markup Language) that can be interpreted by a software module, e.g. the Policy Enforcer POM.

The permissions may be described for example using the permission format used in the Java language: Permission Type—Object—Action.

Specifically, the Object parameter may comprise a user profile property or an identifier referring to a set of properties (e.g. NetworkSettings).

The Action parameter may have e.g. the following values:
NoChange: in order to indicate that the property or set of properties can not be modified;
FreeChange: in order to indicate the property or the set of properties can be freely modified;
ChangeIn(Range): in order to indicate that the property can be modified with a value comprised within the specified Range; the Range parameter may be expressed as a list of items separated e.g. by commas (“Value_{—}1”, “Value_{—}2”, “Value_{—}3”, . . . ) or by a lower limit and an upper limit (“Min_Value” . . . “Max_Value”); the allowed values may also be expressed through regular expressions (e.g. “*.tim.it” may identify any web address within the tim.it domain).

By way of example, it may be assumed that the Policy Enforcer POM may access, through the Profile Manager PRM, parameters of the user profile that are hierarchically organized according to a tree structure as in the example below:

UserInterface

BackgroundColor

BackgroundImage

BackgroundImagePosition

MenuSettings

MenuStyle

MenuFontType

MenuFontSize

MenuMaxItems

. . . . . .

NetworkSettings

SMSServiceCenter

GPRSConnectionUser Uname

GPRSConnectionPassword

GPRSConnectionAddress

A possible partial representation of a policy with the corresponding permissions may be for example the following:

UserInterfacePerm UserInterface.BackgroundColor NoChange

the BackgroundColor property of the User Interface element can not be modified

UserInterfacePerm UserInterface.BackgroundImage FreeChange

the BackgroundImage property of the User Interface element can be freely modified

MenuSettingsPerm MenuSettings.MenuStyle ChangeIn(Icons,List,Animated)

the MenuStyle property of the MenuSettings element can be modified and should be selected between the values ‘Icons’, “List” and “Animated”

MenuSettingsPermMenuSettings.MenuFontSize ChangeIn(8 . . . 12)

the MenuFontSize property of the MenuSettings element can be modified and should be selected within the range from 8 to 12

MenuSettingsPermMenuSettings.MenuMaxItems ChangeIn( . . . 20)

the MenuMaxItems property of the MenuSettings element can be modified and should be selected lower or equal to 20

NetworkSettingsPerm NetworkSettings NoChange

all the properties of the NetworkSettings set can not be modified

Policy Enforcer

According to its best mode, the software module called Policy Enforcer POM has the following tasks:
receiving the policy file from the mobile telephonic operator;
validating the policy file, i.e. checking that it is in a correct format;
parsing the policy file, i.e. transforming from the format used for operator→terminal transmission to the format of the internal data structure adapted for being processed by the policy enforcer during normal operation of the mobile telephonic terminal;
intercepting any modification request by any application present in the mobile telephonic terminal in order to check its compatibility with the rules of the policy file;
providing an API [Application Programming Interface] to the Profile Manager PRM (i.e. the application used by the User U to access and modify its user profile—this application is called “Control Panel” by SonyEricsson and “Tools/Settings” by Nokia) and to other applications resident in the terminal for the following operations:
upon request, returning the admissibility of a certain operation before carrying out this operation (e.g. can the background colour be set to yellow ?);
upon request, returning the list of admissible values for a certain property or parameter of the user profile (e.g. what are the admissible background colour?).

Through the Policy Enforcer POM software applications may request and check the conditions to be satisfied by the modification of any user profile element or parameter. The actual modification of the user profile is carried out by the Profile Manager PRM.

For example, the Policy Enforcer POM may implement one or both of the following two procedures.

The first procedure provides that submitting a profile parameter (intended to be modified) the Policy Enforcer POM consults the policy file received from the operator and replies according to one of the following possibilities:
“modification denied”, as the parameter (functionality or feature or property) has been defined by the operator as not modifiable by the user;
“modification free”, as the parameter (functionality or feature or property) has not been constraint in any way by the operator;
“modification limited” (e.g. to the values V1, V2, . . . Vn or to the range or . . . ), as the parameter (functionality or feature or property) is defined by the operator as modifiable by the user under certain conditions.

For example, to the request to modify the terminal display background image, the Policy Enforcer POM could reply with “modification denied”, “modification free”, “modification limited” to the values “Image1.png”, “Image2.png”, “Image3.png”.

This first procedure is useful especially for those applications that interact with the User U as, according to the reply by the Policy Enforcer POM, it is possible correspondingly and adequately to guide the User U in its following steps, e.g. selections.

The second procedure provides submitting the name of a profile parameter, which is intended to be modified, and its new value, which is intended to be set; consequently, the Policy Enforcer POM consults the policy file received from the operator and replies a boolean value, e.g. “true”/“false” or “yes”/“no” depending on whether the intended modification is compatible with the constraints set by the permissions present in the policy file.

This second procedure is useful especially for those applications that intend to modify certain aspects of the user profile without Interacting with the User U.

Alternatively to this second procedure, it is possible to implement an interception system in the Policy Enforcer POM; this interception system should be able to intercept any call to the modification methods of the user profile (that need particular execution permissions such as “set_background_Image(image)”); this system could be similar e.g. to the system implemented in Java (see its SecurityManager). In this case, any call to the user profile modification methods by the applications is intercepted by the execution environment (e.g. the operating system or the Java Virtual Machine) that enables the execution of the modification only after that the Policy Enforcer POM has checked its compatibility with the permissions present in the policy file.

The interface provided by the Policy Enforcer POM may be implemented e.g. by an API in a programming language suitable for the specific mobile telephonic terminal where the present invention is used; for example, the programming language can be Java or C++.

Method Best Mode

In order to limit the freedom of the User U to modify or customize the parameters (e.g. functionalities, features, . . . ) of the user profile, typically of a mobile telephonic terminal, according to the permissions set by the operator, typically a mobile telephonic operator, through the policy file, it is necessary that the applications that modify these parameters, either interacting with the User U or not interacting with the User U, are suitably programmed so that such modifications are authorized and/or checked by the Policy Enforcer POM.

It is to be noted that the present invention may also be implemented without a Policy Enforcer POM, in this case, the check of the rules in the policy file could be carried out directly by each application that needs to modify the parameters of the user profile.

In general, an application present in the mobile telephonic terminal can try to modify a parameter of the user profile through a functionality provided by the execution environment (e.g. the operating system of the Java Virtual Machine).

The call to this functionality may be intercepted by the execution environment; thereafter, a check is carried out of the compatibility of the requested modification with the rules of the policy file. In case of positive check, the modification to the user profile is carried out; in case of negative check, the modification is cancelled.

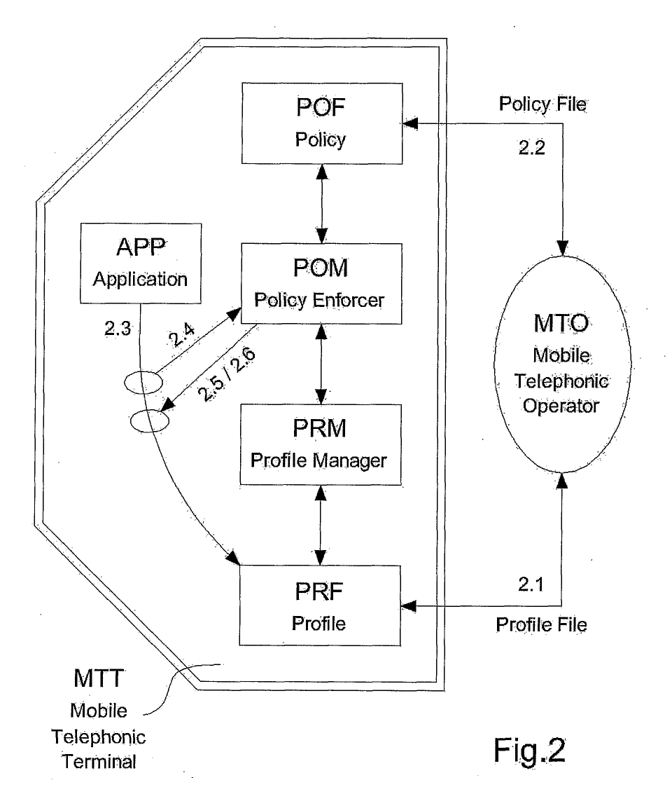

FIG. 2 shows the flows of interaction between the various software modules in the case when an Application APP modifies the user profile without interaction with the User U.

The following steps are provided:

2.1 the manufacturer of the Mobile Telephonic Terminal MTT or the Mobile Telephonic Operator MTO installs an initial user profile into the terminal MTT by sending a Profile File;

2.2 the Mobile Telephonic Operator MTO transfers into the terminal MTT the Policy File; such transfer may take place via the mobile telephonic network, e.g. through OTA [Over-The-Air] standard, or via a wired network, e.g. fixed telephonic network or Internet, or via a removable storage media (typically a solid-state storage media), e.g. the SIM card or a MultiMedia card;

2.3 the Application APP present in the terminal MTT tries to modify a parameter of the user profile by changing its current value into a new value;

2.4 the user profile modification operation made available by the execution environment (e.g. the operating system or the Java Virtual Machine) is Intercepted by the execution environment itself;

2.5 if the new value is not allowed by the permissions of the Policy File, the Policy Enforcer POM denies the modification;

2.6 if the new value is allowed by the permissions of the Policy File, the Policy Enforcer POM applies the modification.

In general; the Profile Manager PRM can be considered one of the many applications present in a mobile telephonic terminal that requires to modify one or more parameters of the user profile; actually, the Profile Manager PRM is the typical application that requires to modify the parameters of the user profile as it is the application that should be used by the User U to interactively modify the user profile.

In this case, in addition to the flow described above, the Application APP may use the API made available by the Policy Enforcer POM in order to customize e.g. appropriately and dynamically the user interface. If, for example, a parameter of the user profile can not be modified by the User U, the user interface may highlight this situation by an appropriate graphic display or may not highlight this situation at all. If a parameter of the user profile can be modified by the User U, the user interface may guide the user in selecting an admissible value Instead of leaving the User U free to set any value and then providing an error message or a modification denial.

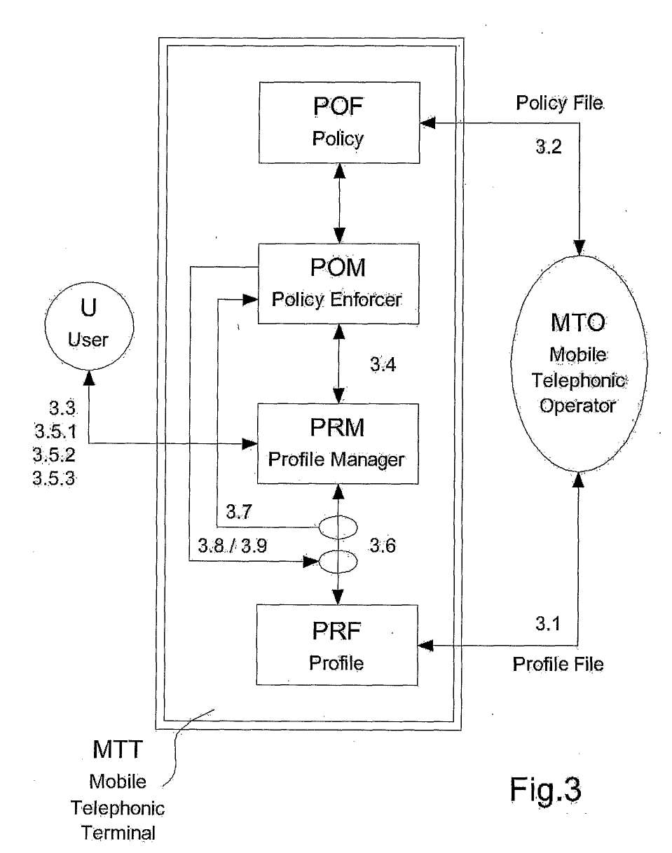

FIG. 3 shows the flows of interaction between the various software modules in the case when an application modifies the user profile with interaction with the User U.

The following steps are provided:

3.1 the manufacturer of the Mobile Telephonic Terminal MTT or the Mobile Telephonic Operator MTO installs an initial user profile into the terminal MTT by sending a Profile File;

3.2 the Mobile Telephonic Operator MTO transfer into the terminal MTT the Policy File; such transfer may take place via the mobile telephonic network, e.g. through OTA [Over-The-Air] standard, or via a wired network, e.g. fixed telephonic network or Internet, or via a removable storage media (typically a solid-state storage media), e.g. the SIM card or a MultiMedia card;

3.3 the User U requests a modification of a certain parameter of the user profile through the Profile Manager PRM by changing its current value into a new value;

3.4 the Profile Manager PRM Interacts with the Policy Enforcer POM in order to check the possibility to carry out the requested modification;

3.5 the Profile Manager PRM interacts with the User U according to this check:

3.5.1 If the certain user profile parameter can not be modified, the interaction is terminated;

3.5.2 if the certain user profile parameter can be modified freely, the User U Inputs the desired new value;

3.5.3 if the certain user profile parameter can not be modified limitatively, the User U sets the new value within predetermined limits;

3.6 in cases 3.5.2 and 3.5.3, the modifications to the user profile parameters that fall within the permissions given to the User U by the Operator MTO are applied;

3.7, 3.8 and 3.9 the system for intercepting and checking the requests of modifications by the User U of the execution environment and of the Policy Enforcer POM should preferably remain always active; anyway, the result of the interception and check should always be positive as the Profile Manager PRM should have already pre-validated the modification requests as provided for under step 3.4. Anyway, this interception and checking system may advantageously protect the user profile from fraudulent attempts of modifications.

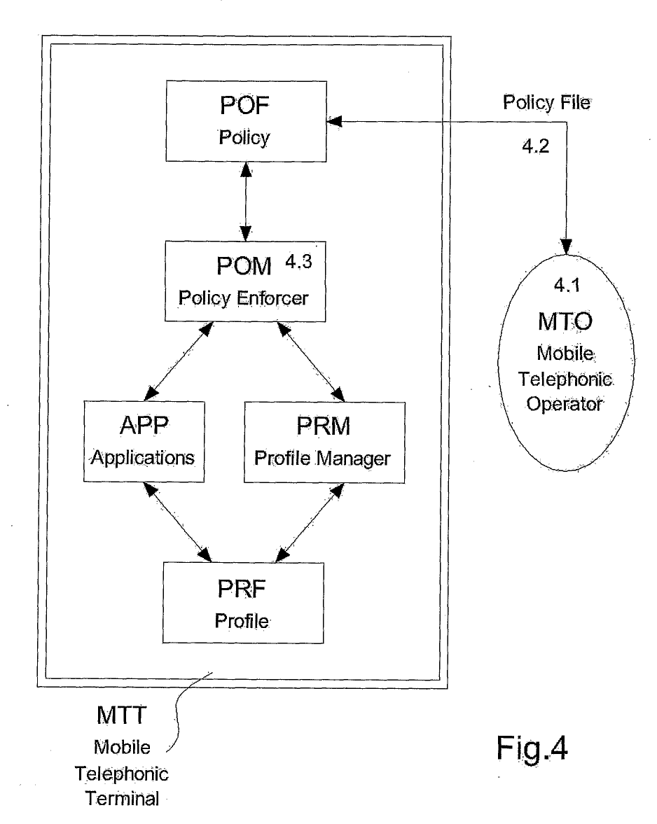

FIG. 4 shows the flows of interaction between the various software modules in the case when the Mobile Telephonic Operator MTO decides to change one of more permissions to the User U.

Before such change, the Applications APP resident and running in the Mobile Telephonic Terminal MTT interact with the Policy POF, the Profile PRF, the Policy Enforcer POM and the Profile Manager PRM and described above, particularly with reference to FIG. 2 and FIG. 3.

The following steps are provided:

4.1 the Mobile Telephonic Operator MTO decides to change one or more permissions to one user (or to a set of users) and therefore to modify the Policy File associated to this one user (or to this set of users);

4.2 the Mobile Telephonic Operator MTO transfer into the Mobile Telephonic Terminal MTT of this one user (or into the terminals of each of the set of users) the modified Policy File; such transfer may take place via the mobile telephonic network, e.g. through OTA [Over-The-Air] standard, or via a wired network, e.g. fixed telephonic network or Internet, or via a removable storage media (typically a solid-state storage media), e.g. the SIM card or a MultiMedia card;

4.3 the Policy Enforcer POM receives the modified Policy File and updates its internal data; thereafter the Policy Enforcer POM will use the new permissions.

Architecture and Apparatus

In the preceding pages and in the annexed drawings, a simplified architecture has been considered in order to have a good and simple description of the method according to the present invention.

In general, the architecture to be considered comprises at least a telephonic operator, typically a mobile telephonic operator, a plurality of telephonic terminals, typically mobile telephonic terminals (e.g., GSM, UMTS), a plurality of users. For the sake of simplicity and as it is very common, it is assumed that a terminal is used by only one user, i.e. its owner, and therefore only one user profile is associated to a telephonic terminal.

This architecture may be replicated for different telephonic operators.

At the moment, fixed telephonic terminals currently on the market does not provide real possibility to customize their operation according to the preferences of its user; anyway, in the future, this possibility is not to be excluded and therefore the present invention can find application even in this case.

In order to implement the method according to the present invention, both the equipments of the telephonic operator and the telephonic terminals of the users have to be appropriately designed; this regards particularly the one or more policy files that store information relating to the possibility to modify one or more operation parameters of telephonic terminals.

Regarding the equipments of the telephonic operator, they have to comprise devices for storing at least one policy file and devices for providing said at least one policy profile to one or more telephonic terminals.

It is advantageous that such providing devices are adapted to transmit said at least one policy profile to one or more telephonic terminals; basically, this can be carried out in three different ways:

A) via a mobile telephonic network, in particular through OTA standard;

B) via a wired network, in particular a fixed telephonic network or Internet;

C) via a removable storage media, in particular a SIM card or a MultiMedia card.

Possibility A is particularly useful for modifying the permissions to the users during normal operation of the telephonic terminals at any time without any help or cooperation from users.

Possibility B is particularly useful for modifying the permissions to the users when a telephonic terminal is sold to a user e.g. In a shop.

Possibility C finds in particular two applications. Multimedia cards can be easily distributed through shops and can be easily applied to telephonic terminals by the users themselves so that permissions to users are easily modified after sale. SIM [Subscriber Identification Module] cards are applied to telephonic terminals at least in order to Identify the user (e.g. for billing) and are provided to users by a corresponding telephonic operator so that permissions to the user by the telephonic operator can be effectively associated thereto.

As already highlighted, through the method according to the present invention, a telephonic operator may easily provide permissions to different users through only one policy file having a standard format that can be interpreted by telephonic terminals of different models and by different manufacturers.

Anyway, it has to be expected that a telephonic operator may be interested in providing different permissions to different groups of users; for example, a first group of users with a first subscription type may have a first set of permissions and a second group of users with a second subscription type may have a second set of permissions. In this case, there will be a first policy file for the first group of users and a second policy file for the second group of users. The telephonic operator may decide or need to modify the permissions for the first group of users, i.e. the first policy file, and not for the second group of users; in this case, the telephonic operator will provide the modified first policy file only to the users of the first group e.g. through a multicast procedure. The update of the policy file may be carried out automatically or with the help or cooperation of the users (e.g. wireless download operation or wired connection to a server of the telephonic operator).

Regarding the telephonic terminal, the implementation of the customization method according to the present invention may be carried out entirely by the telephonic terminal (suitably arranged) or by the combination of a user telephonic card (e.g. a suitably arranged SIM or USIM card) applied to a telephonic terminal (suitably arranged).

First of all, it is important to clarify that the operation parameters of the user profile may be divided into two classes:
first class: those relating to the interaction with the user (e.g. colours and sounds used by the user interface, . . . ), and
second class: those relating to the interaction with the telephonic network (e.g. telephone numbers of service centres, parameters of data transfer, . . . ).

The operation parameters of the first class are connected to the technical features of the telephonic terminal while the operation parameters of the second class are connected to the technical features of the telephonic operator.

If the implementation of the customization method according to the present invention is to be carried out entirely by the telephonic terminal, the telephonic terminal, in particular a mobile telephonic terminal, comprises a profile file storing information relating to its operation parameters (information stored in said profile file being modifiable by a user of the telephonic terminal) and a policy file storing information relating to the possibility to modify one or more of said operation parameters by a user of the telephonic terminal. In this case, there is no problem in storing and using any operation parameter, including those belonging to the above mentioned first class, in the profile file as the profile file is associated to the telephonic terminal.

It is to be noted that in some countries mobile phones do not have the possibility to read user telephonic cards and the subscriber identification is permanently (or semi-permanently) stored into the mobile phone directly or indirectly by the telephonic operator.

If the implementation of the customization method according to the present invention is to be carried out by the combination of a user telephonic card applied to a telephonic terminal, it has to be considered that the profile file may be stored:
entirely within the telephonic terminal,
entirely within the user telephonic card, or
partially within the telephonic terminal and partially within the user telephonic card;

anyway, in this case, the policy file (storing information relating to the possibility to modify one or more of the operation parameters in the profile file) is advantageously stored entirely within the user telephonic card.

This kind of implementation has the advantage that if a user buys a new telephonic terminal or uses different telephonic terminals, the permissions are easily transferred by moving his user telephonic card.

If the profile file is entirely stored within the user telephonic card and if a user buys a new telephonic terminal or uses different telephonic terminals, there is the further advantage that the user preferences (in the user profile) are easily transferred by moving his user telephonic card. Anyway, in this case, attention should be paid to the operation parameters belonging to the above mentioned first class; in fact, some settings (e.g. icons used by user interface) of the profile file may not be applicable to any telephonic terminal (e.g. terminal not supporting icons display).

If the profile file is at least partially stored within the user telephonic card, its format need to be standardized so that it can be interpreted by telephonic terminals of different models and by different manufacturers.

1-21. (canceled)

22. A method for customizing the operation of a telephonic terminal or a mobile telephonic terminal of a user, wherein a profile file is provided in the terminal storing information relating to operation parameters of said telephonic terminal or said mobile telephonic terminal, comprising providing in the terminal, a policy file for storing information relating to the possibility to modify one or more of said operation parameters by said user.

23. The method according to claim 22, comprising updating said policy file in said telephonic terminal or said mobile telephonic terminal, by a telephonic operator during the operation of said telephonic terminal or said mobile telephonic terminal.

24. The method according to claim 22, wherein said profile file is managed by a dedicated software profile managing module.

25. The method according to claim 22, wherein said policy file is managed by a dedicated software policy managing module.

26. The method according to claim 25, wherein said policy managing module interprets said policy file and derives policy information.

27. The method according to claim 26, wherein said policy managing module stores said policy information into a data structure according to a predetermined data format.

28. The method according to claim 22, wherein said profile file is managed by a dedicated software profile managing module, and wherein said policy file is managed by a dedicated software policy managing module, and wherein said profile managing module interacts with said policy managing module when said user attempts to carry out modifications on information stored in said profile file.

29. The method according to claim 28, wherein said policy managing module carries out checks on the possibility to carry out said modifications, and denies or allows a modification according to the results of said checks.

30. The method according to claim 25, wherein said policy managing module intercepts attempts by applications to carry out modifications on information stored in said profile file, carries out checks on the possibility to carry out said modifications, and denies or allows a modification according to the results of said checks.

31. The method according to claim 22, wherein said policy file specifies for at least one operation parameter whether said operation parameter can be modified or not by a user.

32. The method according to claim 31, wherein said policy file specifies modification limits for said at least one operation parameter.

33. The method according to claim 32, wherein a modification limit is expressed as a range of values or as a set of values admissible for said at least one operation parameter.

34. The method according to claim 22, wherein said policy file cannot be modified by a or any user.

35. A method for controlling the operation of a telephonic terminal or a mobile telephonic terminal of a user, wherein a profile file is provided in the terminal storing information relating to operation parameters of said telephonic terminal or mobile telephonic terminal, comprising transmitting to the terminal a policy file for storing information relating to the possibility to modify one or more of said operation parameters by said user.

36. The method according to claim 35, wherein transmission of said policy file is carried out via a mobile telephonic network or through an over-the-air standard.

37. The method according to claim 35, wherein transmission of said policy file is carried out via a wired network, a fixed telephonic network or internet.

38. The method according to claim 35, wherein said transmission of said policy file is carried out via a removable storage media, a SIM card or a multimedia card.

39. A telephonic terminal or a mobile telephonic terminal, comprising a profile file storing information relating to operation parameters, comprising a policy file for storing information relating to a possibility to modify one or more of said operation parameters by a user of the telephonic terminal or mobile telephonic terminal.

40. The telephonic terminal or mobile telephonic terminal according to claim 39, comprising an adaptation to carry out a method for customizing the operation of a telephonic terminal or a mobile telephonic terminal of a user, wherein a profile file is provided in the terminal storing information relating to operation parameters of said telephonic terminal or said mobile telephonic terminal, comprising providing in the terminal, a policy file for storing information relating to the possibility to modify one or more of said operation parameters by said user.

41. A user telephonic card comprising an adaptation to be applied to a telephonic terminal or a mobile telephonic terminal, at least for identifying a user, comprising a profile file storing information relating to operation parameters of the telephonic terminal to which a card is applied, comprising a policy file for storing information relating to the possibility to modify one or more of said operation parameters by said user.

42. The user telephonic card according to claim 41, comprising an adaptation to carry out a method for customizing the operation of a telephonic terminal or a mobile telephonic terminal of a user, wherein a profile file is provided in the terminal storing information relating to operation parameters of said telephonic terminal or said mobile telephonic terminal, comprising providing in the terminal, a policy file for storing information relating to the possibility to modify one or more of said operation parameters by said user, when applied to a telephonic terminal or a mobile telephonic terminal.
